(19) United States
(12) Patent Application Publication
(10) Pub. No.: US 2006/0184392 A1
(43) Pub. Date: Aug. 17, 2006

(54) Healthcare procedure management and clinical alerting system and method

(76) Inventors: Brian DelMonego, Chester Springs, PA (US); Betty Fink, Bear, DE (US); Gary Grzywacz, Harleysville, PA (US); James Pressler, West Chester, PA (US); Donald Taylor, Downingtown, PA (US); Arnold Teres, Broomall, PA (US)

Correspondence Address: Siemens Corporation;Intellectual Property Department, 170 Wood Avenue South, Iselin, NJ, 08830, US

(21) Appl. No.: 11/273,182

(22) Filed: Nov. 14, 2005

Related U.S. Application Data
(60) Provisional application No. 60/627,370, filed on Nov. 12, 2004.

(51) Int. Cl. G06Q 50/00

(52) U.S. Cl. 705/2

(57) ABSTRACT

The embodiments of the present invention include a system and method for alerting a user of a potential violation of hospital policies or procedures comprising receiving data identifying a patient and identifying a user administering a particular treatment to the patient, acquiring medical record data of the patient, and generating an alert message indicating a potential violation of hospital policies or procedures associated with the administering of the treatment by the user when at least one predetermined condition for generating the alert message has been met.

This is a non-provisional application of Provisional Application Ser. No. 60/627,370 to DelMonego et al. filed Nov. 12, 2004.

### FIELD OF THE INVENTION

The embodiments of the present invention relate to a computer-implemented healthcare procedure management and clinical alerting system and method, particularly to a system and method for automatically enforcing hospital policies and procedures.

### BACKGROUND OF THE INVENTION

Hospital policies and procedures are put into place for the protection of the hospital, its employees and patients. Existing hospital information systems (HIS) typically fail to provide a way of automatically enforcing hospital policies and procedures. Currently, hospitals manually check an employee's compliance with hospital policies, where these manual checks assess the data entered into a HIS. However, this method is disadvantageous as it is time consuming and there are no assurances that an oversight has not occurred.

Thus, there is a need within the industry for a system and method that automatically enforces hospital policies and procedures, where should it be determined that data or information entered into a HIS is not in compliance with predetermined standard(s) or condition(s) for a particular policy or procedure, an alert message is generated.

### SUMMARY OF THE INVENTION

An exemplary embodiment of the present invention comprises an alert system for use in patient treatment comprising an interface for receiving data identifying a patient and identifying a user administering a particular treatment to the particular patient, a data processor for acquiring the patient's medical record data, and an alert processor for generating an alert message indicating a potential violation of hospital policies or procedures associated with the administering of the treatment by the particular user when at least one predetermined condition for generating the alert message has been met.

### BRIEF DESCRIPTION OF THE DRAWINGS

All functions and steps shown in the Figures may be implemented in hardware, software or a combination of both.

FIG. 1 is a block diagram showing a computer system according to an exemplary embodiment of the present invention.

FIG. 2 is a block diagram showing a computer system according to an exemplary embodiment of the present invention.

FIG. 3 is a block diagram showing method according to an exemplary embodiment of the present invention.

### DETAILED DESCRIPTION

In hospitals or other medical facilities, each medical procedure, medical examination and/or method of administering treatment (collectively referred to herein as “treatment”) to a patient has specific predetermined conditions or standards that help to ensure employees comply with the hospital's policies and standard procedures, thereby increasing efficiency and the quality of patient care.

An embodiment of the present invention comprises a computer-implemented healthcare procedure management and clinical alerting system and method, particularly to a system and method for automatically enforcing hospital policies and procedures, where prior to the administering of any treatment, the necessary data identifying a particular patient as well as a particular user is entered into a database using a customized or individualized worksheet (i.e., where the worksheet is customized to the particular treatment or method of administering such treatment). Thus, the patient's medical record data can be retrieved from the appropriate database, wherein the patient's medical record data is matched against at least one predetermined condition or requirement for the particular method of treatment. In those instances where the patient's medical record data meets or satisfies the at least one predetermined condition or requirement, the user (e.g., a physician, nurse, clinician or other member of a medical team) receives a system generated alert or warning indicating that there is a potential violation of the hospital's policies and/or standard procedures associated with that particular treatment. As a result, the user cannot proceed with treatment until properly authorized. However in those instances where the patient's medical record data does not satisfy the at least one predetermined condition or requirement, no alert message is triggered and the user can continue the treatment uninterrupted.

The alert message or messages generated by the embodiments of the present invention indicate a potential violation of the hospital's policies and/or procedures involved with the treatment, or its administering, to a particular patient by a particular user.

As noted above, an alert message is generated in response to the potential violation of a hospital policy and/or procedure (e.g., a potential safety hazard associated with a particular treatment or user) as defined by the at least one predetermined condition that can include, but are not limited to, (1) the patient's status (e.g., age, gender, medical/physical status (e.g., pregnancy), insurance coverage and the like); (2) a determination that a particular user is not authorized to administer the particular general course of treatment chosen for a particular patient; and/or (3) a determination that the particular user is not authorized to administer a particular course of treatment to a patient at that particular point in the workflow.

In another embodiment of the present invention, upon generating an alert message a task may be automatically added to a healthcare worker's task list wherein it is necessary for the worker to follow-up on the alert message to ascertain whether it has been properly responded to by the user.

In another embodiment of the present invention, an authorized user may override an alert message in some exceptional cases upon having a sufficient level of security clearance, which may be determined based on predetermined parameters such as, for example, the user's depth of medical knowledge, embedded in a password, position within the hospital (e.g., nurse, doctor, or specialist). For example, an alert message can be generated when an unauthorized user attempts to administer a particular course of treatment to a patient, where the alert (e.g., a second message) is simultaneously communicated to an authorized user (e.g., a clinician). Thus, the authorized user can either administer the treatment to the particular patient or the authorized user may permit the originally unauthorized user to administer the particular course of treatment with respect to a particular patient.

The embodiments of the present invention can also restrict access to particular identified users, allow for further predetermined conditions such as supplemental data in addition to the user's password or access code or utilize those methods known in the art for securing information. The supplemental data can include patient medical condition information and user credentials for administering particular treatment. In such cases, supplemental data entry/display screen(s) or other requirements can be initiated without programmer intervention. Similarly, a patient's medical records are generally protected by those methods known to one skilled in the art including, but not limited to, encryption and/or password/access code requirements.

In addition, when an alert message is not properly responded to (i.e., the appropriate supplemental data is entered, an authorized user overrides the alert message, etc.) the system generates at least a second alert message to ensure that the hospital policies and procedures are not violated.

In another embodiment, upon the generating of an alert message a report is generated for documentation of the alert message.

In an exemplary embodiment of the present invention the at least one predetermined condition precedent to generating an alert message can include: (i) a user being in the Image Procedure Status Tracking module, (ii) the patient being female, (iii) the patient being between the ages of 12 and 52, and (iv) the patient being identified as pregnant. Thus upon the user entering the Image Procedure Status Tracking module and entering data that indicate the patient is a 23 year-old female who is pregnant, an alert message is generated whereby unless a certain access level or level of security clearance is indicated by the user, the user cannot proceed.

In another exemplary embodiment of the present invention the at least one predetermined condition precedent to generating an alert message can include requiring a user to enter a security access code to gain access to the patient's medical records data when a patient has a class designation of “V” (representing a VIP patient). Thus, if a user is in the Patient Inquiry module and selects a patient having a class of “V”, the embodiments of the present invention can display a data entry alert screen requesting a security access code. If the user supplies the necessary code, the user may proceed. However, if an incorrect code is provided the user cannot view the patient's medical record data, and is instead returned to the patient selection screen.

In still another exemplary embodiment of the present invention, with respect to administering treatment to a patient or accessing a patient's medical record data the at least one predetermined condition precedent to generating an alert message can include the particular username (log in) of the user since, for example, hospital nurses may not have rights to use a CT (Cat Scan) apparatus for the treatment of a pregnant patient since the treatment could have harmful consequences for a fetus (i.e., there is restricted access unless the user has a particular level of security clearance or a specialist physician is close by). Moreover, further conditions can include the user being in the Imaging Procedure Tracking module, the patient being female, between the ages of 12 and 52 and pregnant. Therefore, if the user is a nurse, an alert message is generated and the nurse may not proceed unless a physician is able to override the alert message and interruption. However, if the user is a physician (which can be indicated by the user's password, supplemental data or other method) then no alert message is displayed. Thus if a pregnant patient is scheduled for a CT exam for Oct. 16, 2005 at 10:30 am and a nurse performs the examination and enters into an embodiment of the present invention, a worklist is displayed on the display screen. As the patient is pregnant, an alert symbol appears in the proximity of the patient's name which indicates that the CT is not allowed unless a physician is in the vicinity. Concurrently, a second message (e.g., using e-mail or other method of communication) can be sent to the physician that is the supervisor or specialist in such cases, whereby the physicians presence is required for the 10:30 am examination.

In still another exemplary embodiment of the present invention, in administering treatment to a patient if the at least one predetermined condition included the requirement for an insurance provider and the patient's medical record data indicates that the patient does not have an insurance provider on record, an alert message can be generated. As a result, the user would need to obtain the necessary information from the patient, unless an authorized user were to override the alert message to allow the treatment to continue.

The embodiments of the present invention enable the hospital or other medical facility to control and/or automate workflow (i.e., a sequence of tasks that support delivery of healthcare to the particular patient) without human intervention based on the at least one predetermined standard condition or requirement, where the condition, can be embedded directly in the application. Thus, the hospital or other medical facility operates more efficiently and provides more effective patient care.

The present embodiments are preferably implemented on a computer, or network of computers as an executable application. The executable application displays on a computer screen, the customized or individualized worksheet (or other electronic form) assigned to a selected treatment or medical department, the patient's medical record data and enables the user to view any generated alert messages.

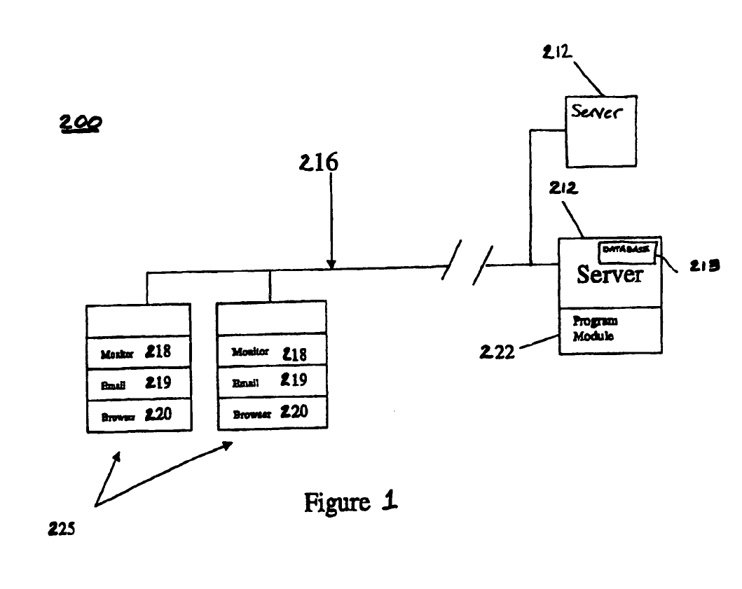

FIG. 1 shows a client-server computer system 200, according to an exemplary embodiment of the present invention which may be utilized to carry out a method according to an exemplary embodiment of the present invention. The computer system 200 includes a plurality of server computers 212 and a plurality of user computers 225 (clients). The server computers 212 and the user computers 225 may be connected by a network 216, such as for example, an Intranet or the Internet. The user computers 225 may be connected to the network 216 by a dial-up modem connection, a Local Area Network (LAN), a Wide Area Network (WAN), cable modem, digital subscriber line (DSL), or other equivalent connection means (whether wired or wireless).

Each user computer 225 preferably includes a video monitor 218 for displaying information. Additionally, each user computer 225 preferably includes an electronic mail (e-mail) program 219 (e.g., Microsoft Outlook®) and a browser program 220 (e.g., Microsoft Internet Explorer®, Netscape Navigator®, etc.), as is well known in the art. Each user computer may also include various other programs to facilitate communications (e.g., Instant Messenger™, NetMeeting™, etc.), as is well known in the art.

One or more of the server computers 212 preferably include a program module 222 (i.e., the executable application described above) which allows the user computers 225 to communicate with the server computers and each other over the network 216. The program module 222 may include program code, preferably written in Hypertext Mark-up Language (HTML), JAVA™ (Sun Microsystems, Inc.), Active Server Pages (ASP) and/or Extensible Markup Language (XML), which allows the user computers 225 to access the program module through browsers 220 (i.e., by entering a proper Uniform Resource Locator (URL) address). The exemplary program module 222 also preferably includes program code for facilitating a method of simulating leadership activity among the user computers 225, as explained in detail below.

At least one of the server computers 212 also includes a database 213 for storing information utilized by the program module 222 in order to carry out the embodiments of the alert system and method. For example, patient medical record data, data identifying a particular patient and a particular user, and the at least one predetermined condition for generating the alert may be stored in the database. Although the database 213 is preferably internal to the server in FIG. 1, those of ordinary skill in the art will realize that the database 213 may alternatively comprise an external database. Additionally, although database 213 is preferably a single database in FIG. 1, those of ordinary skill in the art will realize that the present computer system may include one or more databases coupled to the network 216.

The embodiment of the present invention also include a computer readable medium having embodied thereon a computer program for processing by a machine, the computer program comprising a segment of code for each of the method steps. The embodiments of the present invention also include a computer data signal embodied in a carrier wave comprising each of the aforementioned code segments.

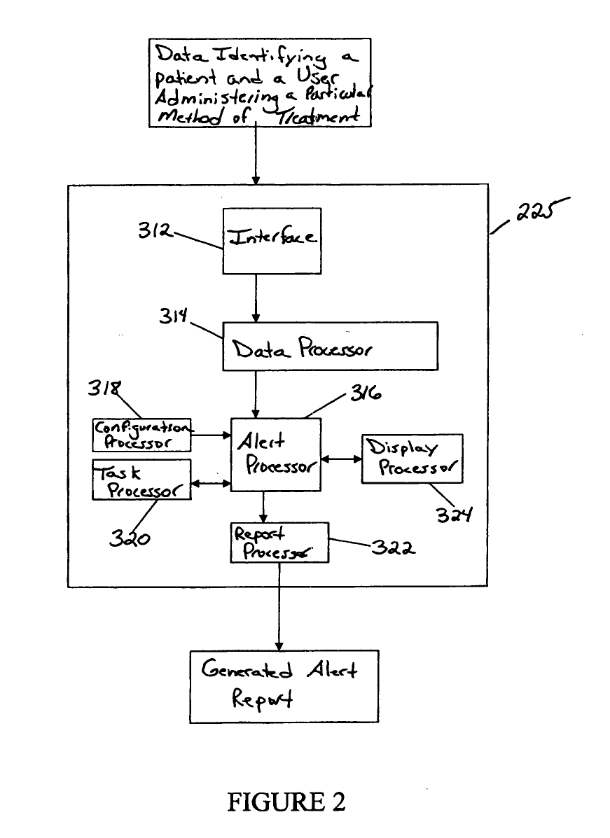

In order to perform some of the functions of the method for enforcing hospital policies and procedures with respect to patient treatment, as illustrated in the exemplary embodiment of FIG. 2, at least one of the user computers 225 or server computers 212 may include an interface 312 for receiving data identifying a patient and identifying a user administering a particular method of treatment, a data processor 314 for acquiring the patient's medical record data and an alert processor 316 for generating at least one alert message indicating a potential violation of hospital policies and/or procedures with respect to administering of particular treatment by the particular user when at least one predetermined condition for generating the alert message has been met. At least one of the user computers 225 or server computers 212 may also include a configuration processor 318 for enabling a user to enter further predetermined alert condition(s) such as, for example, indicating patient medical condition information, user credentials for administering particular treatments and determining conditions indicating a potential violation of hospital policies and/or procedures with a particular user administering a particular treatment to a particular patient. At least one of the user computers 225 or server computers 212 may also include a task processor 320 for automatically adding a task to a healthcare worker's task list wherein it is necessary for the worker to follow-up on the alert message to ascertain whether it has been properly responded to by the user. At least one of the user computers 225 or server computers 212 may also include a report processor 322 for generating of a report for documentation of the alert message.

At least one of the user computers 225 or server computers 212 may also include a display processor 324 for initiating generation of data representing a display image, enabling viewing of the alert message and visual confirmation of the data contained therein.

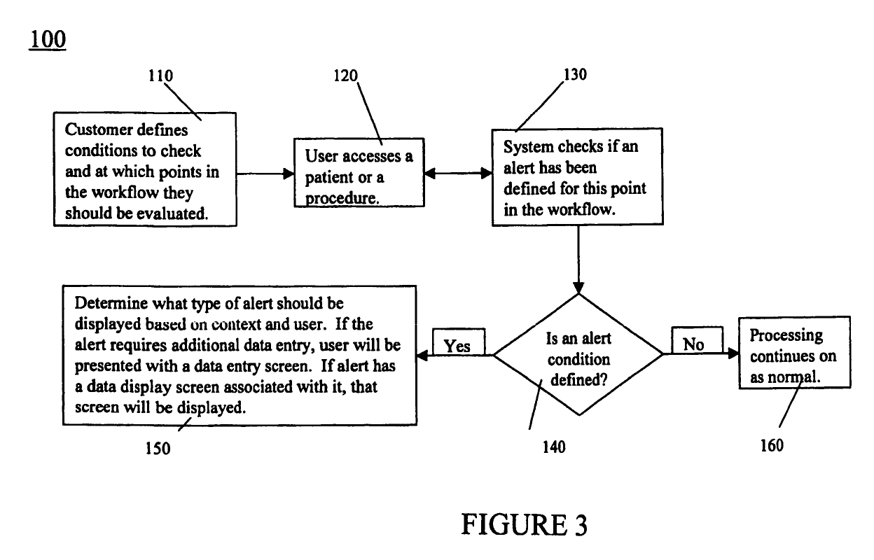

FIG. 3 is a block flow diagram showing an exemplary method 100 for enforcing hospital policies through generating alert messages that includes a first step of 110 a user defining the desired predetermined conditions and the point in the workflow at which they should be evaluated. At step 120, a user attempts to access a patient's medical record data or a particular treatment procedure. At step 130, there is a determination whether at least one predetermined alert condition has been defined for the particular point in the workflow. At step 140, a determination is made whether the at least one predetermined alert condition has been met. If the at least one predetermined alert condition has not been met, then in step 160 no alerts are dispatched and the treatment continues in its normal course. However, if at least one predetermined alert condition has been met, then in step 150 a determination is made regarding the type of alert message to be dispatched based on the user and the context. If the alert message requires supplemental data entry, the user will be presented with a data entry screen. If the alert has a data display screen associated with it, that screen will be displayed.

An executable application as used herein comprises code or machine-readable instruction for implementing pre-determined functions, including those of an operating system, healthcare information system or other information processing systems, for example, in response to a user command or input. An executable procedure is a segment of code (machine-readable instruction), subroutine, or other distinct section of code or portion of an executable application for performing one or more particular processes and may include performing operations on received input parameters (e.g., a response to received input parameters) and provide resulting output parameters.

A processor as used herein is a device and/or set machine-readable instructions for performing tasks. As used herein, a processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device.

As used herein the term “code segment” means a portion of a set of machine-readable instructions, such as a portion of a computer program, or a portion of computer program code.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention.

What is claimed is:

1. An alert system for use in patient treatment comprising:
an interface for receiving data identifying a patient and identifying a user administering a particular treatment to the particular patient;
a data processor for acquiring medical record data of the patient; and
an alert processor for generating an alert message indicating a potential violation of hospital policies or procedures associated with the administering of the treatment by the particular user when at least one predetermined condition for generating the alert message has been met.

2. The system according to claim 1, further comprising:
a display processor for initiating generation of data representing a display image, enabling viewing of the alert message and visual confirmation of data contained therein.

3. The system according to claim 4, further comprising:
a configuration processor enabling the use of supplemental data including patient medical condition information and user credentials for administering particular treatments.
The system according to claim 1 further comprising:

4. The system according to claim 1, further comprising:
the alert processor generating at least a second alert message when the user has not properly responded to the original alert message.

5. The system according to claim 1, further comprising:
a task processor automatically adding a task to a healthcare worker's task list wherein it is necessary for the worker to follow-up on the alert message to ascertain whether it has been properly responded to by the user.

6. The system according to claim 1, further comprising:
a report processor for generating a report for documentation of the alert message.

7. The system according to claim 1, wherein the at least one predetermined condition for generating the alert message is selected from the group consisting of patient status, a determination that a particular user is not authorized to administer the particular general course of treatment chosen for a particular patient, and/or a determination that the particular user is not authorized to administer a particular course of treatment to a patient at that particular point in the workflow.

8. The system according to claim 1, wherein the alert processor initiates generating a second message for communication to an authorized user to at least one of, (a) enable the authorized user to authorize the user to administer the treatment to the particular patient, and (b) alert the authorized user to administer the treatment to the particular patient.

9. A method for alerting a user of a potential safety hazard comprising:
receiving data identifying a patient and identifying a particular user administering a particular treatment to the particular patient;
acquiring medical record data of the patient; and
generating an alert message indicating a potential violation of hospital policies or procedures associated with the administering of the particular treatment by the user when at least one predetermined condition for generating the alert message has been met.

10. The method according to claim 9, further comprising:
initiating generation of data representing a display image, enabling viewing of the alert message and visual confirmation of data contained therein.

11. The method according to claim 9, further comprising generating a second message for communication to an authorized user to at least one of, (a) enable the authorized user to authorize the user to administer the treatment to the particular patient, and (b) alert the authorized user to administer the treatment to the particular patient.

12. The method according to claim 9, further comprising enabling the use of supplemental data including patient medical condition information and user credentials for administering particular treatments.

13. The method according to claim 9, further comprising:
generating at least a second alert message when the user has not properly responded to the original alert message.

14. The method according to claim 9, further comprising:
automatically adding a task to a healthcare worker's task list wherein it is necessary for the worker to follow-up on the alert message to ascertain whether it has been properly responded to by the user.

15. The method according to claim 9, further comprising:
generating a report for documentation of the alert message.

16. The method according to claim 9, wherein the at least one predetermined condition for generating the alert message is selected from the group consisting of patient status, a determination that a particular user is not authorized to administer the particular general course of treatment chosen for a particular patient, and/or a determination that the particular user is not authorized to administer a particular course of treatment to a patient at that particular point in the workflow.

17. A computer system comprising at least one server computer and at least one user computer coupled to the at least one server through a network, wherein the at least one server computer includes at least one program stored therein, said program performing the steps of:
receiving data identifying a patient and identifying a user for administering a particular treatment to the patient;
acquiring medical record data of the patient; and
generating an alert message indicating a potential violation of hospital policies or procedures associated with the administering of the treatment by the user when at least one predetermined condition for generating the alert message has been met.

18. The system according to claim 17, further comprising:
initiating generation of data representing a display image, enabling viewing of the alert message and visual confirmation of data contained therein.

19. The system according to claim 17, further comprising enabling the use of supplemental data including patient medical information and user credentials for administering particular treatments.

20. The system according to claim 17, further comprising:
an alert processor generating at least a second alert message when the user has not properly responded to the original alert message.

21. The system according to claim 17, further comprising
automatically adding a task to a healthcare worker's task list wherein it is necessary for the worker to follow-up on the alert message to ascertain whether it has been properly responded to by the user.

22. The system according to claim 17, further comprising:
generating a report for documentation of the alert message.

23. The system according to claim 17, wherein the at least one predetermined condition for generating the alert message is selected from the group consisting of patient status, a determination that a particular user is not authorized to administer the particular general course of treatment chosen for a particular patient, and/or a determination that the particular user is not authorized to administer a particular course of treatment to a patient at that particular point in the workflow.

24. The system according to claim 17, further comprising generating a second message for communication to an authorized user to at least one of, (a) enable the authorized user to authorize the user to administer the treatment to the particular patient, and (b) alert the authorized user to administer the treatment to the particular patient.

25. A computer readable medium having embodied thereon a computer program for processing by a machine, the computer program comprising:
a first segment of code for receiving data identifying a patient and identifying a user for administering a particular treatment to the patient;
a second segment of code for acquiring medical record data of the patient; and
a third segment of code for generating an alert message indicating a potential violation of hospital policies or procedures associated with the administering of the particular treatment by the user when at least one predetermined condition for generating the alert message has been met.

26. A computer data signal embodied in a carrier wave comprising:
a first segment of code for receiving data identifying a patient and identifying a user for administering a particular treatment to the patient;
a second segment of code for acquiring medical record data of the patient; and
a third segment of code for generating an alert message indicating a potential violation of hospital policies or procedures associated with the administering of the particular treatment by the user when at least one predetermined condition for generating the alert message has been met.
